(19) United States
(12) Patent Application Publication
(10) Pub. No.: US 2014/0337422 A1
(43) Pub. Date: Nov. 13, 2014

(54) ELECTRONIC CONFERENCING METHODS

(71) Applicant: Walter Monk, Arlington, TX (US)

(72) Inventor: Walter Monk, Arlington, TX (US)

(21) Appl. No.: 13/891,844

(22) Filed: May 10, 2013

(51) Int. Cl. H04L 29/06

(52) U.S. Cl. CPC H04L 65/403
USPC 709/204

(57) ABSTRACT

Electronic conferences for a large number of attendees may be facilitated by a preliminary greeting employing live greeters. Such preconferences allow a conference to begin contemporaneously for all attendees while providing early arrivals with introductory information, thus filling what would otherwise be a vacuous wait. Preferred embodiments for these conferences use outbound initiation: initiating contact with potential attendees.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The instant specification pertains to electronic communications conferences. More particularly, the instant specification pertains to handling large conferences, wherein attendance may number thousands of people. From a different view, the instant specification is of computerized transaction processing facilitating structured communications among multiple people.

2. Background

Teleconferencing has become common in modern day communications, due to its ability to virtually connect participants from all over the world across a telecommunications network. In-person meetings are often impractical. Teleconferencing saves the time and expense of getting all meeting participants in the same room.

Broadly speaking, electronic conferencing provides for the real-time exchange of information between people who are not in the same physical space. Electronic conferencing includes audio, video, text, data, and multimedia communications via telephone, videophone, text-messaging, internet, or any other telecommunication network

One example of an audio-based conference is a telephonic conference or conference call. Conference calls allow groups of participants, from a few to tens of thousands, to communicate by telephone. Businesses often use conference calls to help coworkers communicate across remote locations.

Web conferencing expands upon audio-based conferencing by providing for communication of audio, video, text, data, and multimedia across the Internet.

Although there are many flavors of electronic conferencing, they all rely upon the same basic principles of initiation, communication, control, and monitoring.

There are two basic categories of techniques for initiating connection to an electronic conference: 1) inbound initiation; and, 2) outbound initiation.

With inbound initiation, participants proactively connect to a pre-arranged conference at a predetermined time. In an exemplary telephonic conference, participants dial in, where they may be: 1) presented with a message that provides information about or related to the conference before being transferred to the conference; or 2) connected directly to the conference and immediately connected to other participants who have previously dialed-in; or 3) if they are the first to dial-in, connected directly to the conference to wait for other participants to dial in.

In an exemplary telephonic conference system, inbound initiation may be accomplished by dialing a designated phone number. Other exemplary forms of inbound initiation for electronic conferencing may involve logging into a designated website, connecting to a designated chat room, or sending a text message to a designated number.

Variations of inbound initiation are disclosed by: U.S. Pat. No. 5,483,588 (Eaton); U.S. Pat. No. 5,886,734 (Ozone); US 2003/0158900 (Santos); US 2007/0019798 (Voight); U.S. Pat. No. 7,343,008 (Frankel); and U.S. Pat. No. 8,239,454 (Palermo).

U.S. Pat. No. 5,483,588 (Eaton) disclosed a teleconferencing system with automated “named introductions” of a caller. “A caller attempting to join a teleconference is prompted to enter identification information by generating corresponding DTMF signals. The caller's identification is used to index the caller's profile stored in memory. The profile includes a memory address pointer to the location at which data representative of the spoken name of the caller is stored.”

U.S. Pat. No. 5,886,734 (Ozone) disclosed a videoconferencing system in which “conference participants are initially greeted by playback of stored audio and video messages and then placed in an automated queue. The automated queue is a holding queue from which an operator can select the next available conference participant in the queue and perform . . . conferencing functions for the participant.” Functions include “welcoming the participant, checking audio and video levels, and placing the participant into the conference.”

US 2003/0158900 (Santos) disclosed a teleconferencing system with “conference monitor . . . configured to allow a host to dynamically create a web page to provide an indication of ones of said conference participants who have joined the conference call. A web server may be configured to host the web page for access by one or more of the conference call participants.”

US 2007/0019798 (Voight) disclosed “providing a customized teleconference greeting. The method includes recording a vocalized greeting provided by a host, storing the recorded vocalized greeting, receiving calls from guest terminals operated by guest participants, sending audio greetings for the guest participants to the guest terminals including at least a portion of the recorded vocalized greeting.”

U.S. Pat. No. 7,343,008 (Frankel) disclosed “providing conferencing services where a conference participant is identified by the conferencing system when calling into the system,” and wherein “services are personalized for each user.”

U.S. Pat. No. 8,239,454 (Palermo) disclosed a “telephone conference based communication, entertainment and advertising platform” wherein “revenue can be derived from the sale of advertisement, e.g., mentions of the sponsor over the telephone during the initial greeting and within conferences, as well as from the licensing of the service to media networks as a value added service.”

Inbound initiation has various issues. Participants may be tardy. This becomes multiplicative in conferences with a large number of participants, especially in those with an indeterminate number of participants such as for organizational status reports, investor meetings, or town-hall style meetings. Uncertainty looms over when to officially start the meeting, causing timely participants to wait.

Alternatively, in outbound initiation, participants are contacted by the electronic conferencing system at a pre-programmed time, or in the case of an ad-hoc conference, at the request of a host, moderator, participant, or other party.

With outbound initiation, a list, table, or database of participants, including a means of contacting them (i.e., telephone number, email address, username, etc.) is necessary. An electronic conferencing system initiates connection to these participants with an invitation to join a conference. If a participant accepts an invitation, s/he is connected to the conference. Using outbound initiation, a conference starts in a timely fashion for all connected participants.

Using outbound initiation, participants may be connected directly into the conference. Alternatively, upon response to the outbound invitation, participants may first be presented with a greeting.

This greeting may be pre-stored (that is, pre-recorded), and replayed at the appropriate time, or a greeting may be provided by a live greeter that can interact with participants. A greeting may include any information related to the conference, in one or more of a variety of media: audio, video, text, data, and multimedia.

After the greeting, the participant is transferred to the conference.

Variations of outbound communication for electronic conferencing initiation with use of a pre-stored greeting are disclosed by: U.S. Pat. No. 5,631,904 (Fitser); WO01/47224 (Liss); U.S. Pat. No. 7,852,998 (Smith); US 2005/0276406 (Keohane); U.S. Pat. No. 8,266,535 (Brown); and US 2009/0052646 (McGowan).

U.S. Pat. No. 5,631,904 (Fitser) disclosed “automatically establishing a conference call to a preselected list of prospective participants to the conference call. A subscriber to the conference calling service predefines one or more lists of participants, each list being associated with a different conference call. When the subscriber wishes to initiate a conference call, the subscriber accesses the network and requests that the call be set up. The network originates (e.g., dials) calls to each of the participants on a specified list. The network then bridges these individual calls to establish the conference call.”

WO01/47224 (Liss) disclosed “automatically conferencing a caller to one or more members of a group . . . in which the caller can record a message to be played to one or more contacted members of the group, who are dynamically entered into a conference call with each other and the person contacting the system.”

U.S. Pat. No. 7,852,998 (Smith) disclosed “an automated teleconferencing control system and method” that “reduces conference call setup time by simultaneously out dialing to multiple conferees through a plurality of parallel telecommunications resources. The teleconferencing control system includes the feature of automatically gathering statistics of each connection attempt, as well as many other call aspects, using these statistics to automatically improve the efficiency of subsequent conference call initiations.”

US 2005/0276406 (Keohane) disclosed “a centralized conference call manager . . . for initiating conference calls. Users register with the centralized conference call manager to set up a conference call at a future date and time. When the designated time/date arrive, the centralized conference call manager contacts the various intended attendees using a variety of contact locations (e.g., office telephone, mobile telephone, home telephone, etc.).”

U.S. Pat. No. 8,266,535 (Brown) disclosed a teleforum system “generating simultaneous outbound invitation calls to multiple invitees and transmitting a message to each invitee, inviting him or her to become a teleforum participant. Teleforum participants who accept the invitation are connected to the teleforum in a listen-only mode. During the teleforum, a teleforum participant may request active participation in the teleforum . . . . Active participation may include but is not limited to such activities as: speaking to the teleforum, asking a question, responding to a poll, making a donation, providing information, leaving a message, being transferred to a subconference, receiving feedback from participants, leaving a voicemail, volunteering for future activities or receiving media transmitted outside of the teleforum.”

US 2009/0052646 (McGowan) disclosed “automatically commencing a conference call . . . . The computer automatically calls telephone numbers of conferees at a scheduled time and date and conferences together the conferees who answer their telephones . . . . The computer may connect conferees to one another automatically as soon as the conferees answer their telephones. Optionally, the computer may connect the conferees to one another only after the conferees choose to be connected.”

In some places, there are legal regulations for pre-stored greetings, particularly for telephone-based audio conference calls. In accordance with the FCC's Telephone Consumer Protection Act (TCPA), it is illegal in the United States to call mobile/cellular telephones and play a pre-recorded message. The TCPA provides restrictions against playing most pre-recorded messages to landlines as well. While these laws were designed to protect consumers against telemarketing “robocalls,” they apply also to teleconference greetings.

### BRIEF SUMMARY OF THE INVENTION

The disclosed technology is for electronic conferencing using outbound initiation. Those who accept an invitation are first put into a preconference prior to joining the main electronic conference (econference). A preconference is selected for each participant who accepts an invitation based upon the time taken to respond to the invitation. Preconferences are hosted by live greeters, as contrasted to pre-stored automatons.

The disclosed technology affords minimal waiting time for participants to an econference. The disclosed technology is scalable, allowing the same technique(s) to be employed for an econference with a large number of participants.

### BRIEF DESCRIPTION OF THE SEVERAL VIEWS OF THE DRAWINGS

FIG. 1 is a diagram of an exemplary outbound initiation electronic conferencing system and method employing one or more live greeters.

FIG. 2 is a timing diagram of an exemplary outbound initiation electronic conferencing system employing one or more live greeters, where preconferences are provided prior to the main conference.

FIG. 3 is a diagram of an exemplary rotation of greeters hosting preconferences leading to an econference.

FIG. 4 is a diagram of an exemplary embodiment of a conclave.

FIG. 5 is a diagram of a conclave within an electronic conference.

FIG. 6 is a diagram of receiving, screening, and posing questions to an econference speaker.

### DETAILED DESCRIPTION OF THE INVENTION

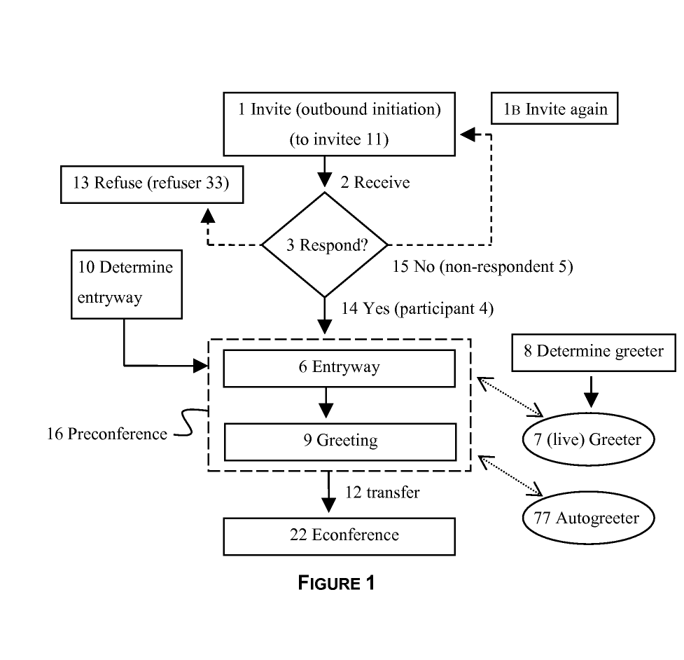

FIG. 1 depicts a flow diagram of an embodiment for conducting an econference 22.

An econference 22 is a conference conducted by electronic means, such as by telecommunications. Telephonic conferences and video-conferences are exemplary econferences. An Internet-based chat room is another exemplary econference.

In a first embodiment, an econference 22 may be largely an interactive two-way experience with participants 4. In this first embodiment, participants 4 may provide input which may alter the proceedings of an econference 22. In absence of indication otherwise, this is the presumed embodiment.

In a second set of embodiments, participant input may alter proceedings, but the input is inherently limited, such that the conductor of the econference selectively responds to input. Such a nominally one-way econference 22 is more specifically termed an epresentation. Unlike more free-form econferences, where disruption from participant interaction is possible, the conductor of an epresentation retains control of proceedings throughout. In one epresentation embodiment, participant interaction does not alter the proceedings.

An invitee 11 is a potential participant invited 1 to join an econference. An invitation 1 is an electronic communication soliciting an invitee 11 to participate in an econference 22.

A potential participant is a party that becomes an invitee 11 via invitation 1. Potential participants are stored in a list, table, or database, along with means of contacting them, such as telephone number, email address, username, or otherwise.

Potential participants may be selected based upon any criteria. Likewise, invitees 11 may be selected from the pool of potential participants based upon any criteria.

In one embodiment, the econferencing system keeps track of past participants 4 and/or invitees 11. The system may also store in memory those who have responded with interest in one or more econferences 22, based upon solicitation by any means. Email, texting, instant messaging, web site advertising and telephonic inquiry are exemplary means.

Invitees 11 may be invited 1 to join a conference by any method, including, but not limited to: telephone, video phone, text message, email, and internet chat. If an invitation is not responded to via one medium, an alternate medium, or an alternate address (such as a different phone number) may be attempted to extend an invitation.

The embodiments disclosed herein employ outbound initiation, but the disclosed technology is equally applicable to inbound initiation. Outbound initiation comprises an econferencing system inviting 1 potential participants. Inbound communication comprises potential participants initiating connection to an econference 22.

A greeter 7 is a live person who communicates with econference participants 4. An autogreeter 77 is a preprogrammed computerized version of a greeter; in other words, an electronic agent. In the simplest embodiment, an autogreeter 77 is a recording with playback which may be electronically triggered.

Invitations are sent 1 to a plurality of invitees 11. This invitation step 1 may be initiated automatically based upon a pre-scheduled econference stored in the memory of an econferencing or other computing system. This invitation step 1 may be initiated by any of a plurality of greeters, by a separate econference host or moderator, by an econference participant, or by any other automatic or manual means.

An invitee 11 receives 2 an econference invitation. An invitee 11 that accepts an invitation 14 becomes a participant 4. In the preferred embodiment, a participant 4 is a person who has an active connection to the proceedings of econference 22, including any preliminary proceedings prior to an econference to which a participant may be connected, such as a preconference 16. In another embodiment, a participant 4 may be a software agent with recording capabilities.

An active connection affords the respective services and interactive capabilities for a participant during an econference 22. In a first set of embodiments, an active connection allows participant interaction, to some degree and at least during some time, during the instant proceedings. In the most open-ended embodiment, an econference 22 allows for user interaction via all media available, and for the vast majority, if not all, of an instant econference 22. This embodiment resembles a live conference in offering free-for-all interaction, however problematic to orderly proceedings.

In another exemplary embodiment, participant interaction may be limited to input by a certain means, such as electronic device input (e.g., keyboard/keypad and screen pointing device), while not allowing for audio/voice (or video/audio/multimedia/data/text) input. In another exemplary embodiment, participant interaction, however fulsome via media, is limited to certain portions of an econference, such as during a question and answer session. In another exemplary embodiment, participant interaction may be limited to certain purpose(s), such as polling or surveys. In such embodiments, interactions may be filtered, such that only some participants are allowed interaction, while others are not. Alternately, interaction may be tentatively limited by input means (e.g., only keys and screen pointing devices) until fuller input means (e.g., audio/video) are granted. Various combinations of these embodiments are envisioned.

During epresentations, an active connection limits participant interaction in some way, and/or during some portion of the proceedings, as disclosed foregoing, such that the conductor of the proceedings assuredly retains control over the entire course of the conference. One epresentation embodiment—the most restrictive—only provides reception to proceedings; not allowing user interaction.

The characteristics of participant attendance in an econference may be recorded for statistical reasons. Examples: how the invitee 11 was successfully contacted; the time elapsed between the initiation of an invitation and invitee response; whether a participant 4 disconnected, and, if so, how long the participant 4 participated before disconnecting.

An invitee 11 that refuses 13 an invitation is a refuser 33.

A non-respondent 5 is an invitee 11 that fails to respond 15. A non-respondent 5 may be re-invited 1b by a secondary invitation method. Secondary invitations may be through the same network as the first invitation, or by a different network or medium. For example, if a non-respondent is initially contacted via a first telephone number, the secondary invitation may be to an alternate (second) telephone number, or the secondary invitation may be via text message, email, internet based communication, or any other telecommunication method.

Invitees 11 may respond 3 to an invitation via interaction with an interface. Exemplary interfaces include hardware or software interfaces of a communications or computing device. For example, invitee acceptance 14 for an econference may be answering a telephone call, answering a videophone call, responding to a text message, joining a chat room, interacting with a hyperlink, interacting with a GUI software element, interacting with an active web page element, or any other user interaction that is responsive to an invitation. Such interfaces, of considerable variety, are well known in the prior art.

In one outbound initiation embodiment, a text or multimedia message, such as an email, is sent to a portable telephonic and/or computing device, such as a mobile phone, of an invitee 11. The message contains interactive content, such as a hyperlink. Various forms of such interactive content are well known in the prior art. An invitee affirmatively responds 14 by activating the interactive content, whereupon the interactive content connects to a preconference 16 or econference 22.

In the preferred embodiment, a participant 4 is first connected to an entryway 6, which is the first portion of a preconference 16, and then presented with a greeting 9, which is the second portion of a preconference 16. A preconference 16 is a preliminary multiple-party monologue or dialogue or conversation prior to an econference 22, typically with fewer participants than an econference. A plurality of preconferences 16 may lead into a single econference 22.

In one embodiment, a choice is provided to a participant 4 during a preconference 16 to select one of a plurality of econferences 22 to join. In one embodiment, a participant 4 may join a second econference during or after a first econference. Econferences 22 may be sequential, or multiple econferences may be held contemporaneously.

Econferences 22 may have identical or different content. Econferences 22 may consist of prerecorded content or live performance, or a mixture therein.

An entryway 6 of a preconference 16 is the initial portion of the preconference 16, during which new participants 4 may join. In contrast, during the later part of a preconference 16—the greeting 9—no new participants join, at least in the preferred embodiment, and unless otherwise explicitly stated. A greeting 9 is the portion of a preconference 16 where a greeting is provided to an established number of participants 4. In the preferred embodiment, the mechanism of adding new participants 4, such as during an entryway 6, ceases once a greeting 9 gets underway. In certain embodiments, notably those that allow others 44 to join a preconference 16, additional people may be added to a greeting 9 via invitation by a participant 4 in a preconference 16.

The term econference 22 refers to communication among or to participants 4 coming from one or a plurality of preconferences 16.

Upon positively responding to 14 (accepting) an invitation, a participant 4 is connected to a preconference 16 and corresponding entryway 6 among a plurality of possible preconferences with corresponding entryways. The determination 10 of a particular preconference depends upon the duration between an invitation and invitation acceptance.

In a first embodiment, the timing for the start of each greeting 9 is predetermined. In a second embodiment, a greeting 9 for a preconference 16 begins when a threshold number of participants have entered the entryway 6 for the preconference. In a third embodiment, as a variation of the second embodiment, a predetermined maximum period of time may be set between the start of the entryway and the start of the greeting.

In the preferred embodiment, an entryway 6 is conducted by a greeter 7. A greeting 9 is also conducted by a greeter 7. A greeter 7 converses with participants 4 during an entryway 6 and a greeting 9.

In an ersatz embodiment, a preconference may be conducted by an autogreeter 77. All or part of an entryway 6 or greeting 9 may be provided by an autogreeter 77. An entryway/greeting/preconference conducted by an autogreeter is respectively termed a canned entryway/greeting/preconference. For example, in one embodiment, a canned greeting is conducted by an autogreeter 77, possibly only for a portion of the greeting 9. In another embodiment, an autogreeter 77 may be employed for a portion of an entryway 6.

After being connected to an entryway 6, after some short duration, a participant 4 is presented with a greeting 9. A greeting 9 may include the purpose of the econference 22, introductory information, background information, a guest list of potential participants, econference options, anticipated econference length, any other information related to the econference 22, or any combination thereof.

In the preferred embodiment, since new participants 4 may still be joining a preconference 16 during the entryway 6, key information is reserved for the greeting 9, and not presented during the entryway 6.

In the preferred embodiment, a greeting 9 is presented by a greeter 7 without participant 4 interaction. In an alternate embodiment, a greeting 9 may be interactive.

Greeters 7 comprise a queue of a plurality of possible greeters 7 for preconference 16. The number of greeters 7 assigned to an econference 22 may vary based upon any number of factors, including, though not exclusively: availability of greeters 7, number of participants 4, and expected econference 22 size. Greeters 7 may be located in a single location, or geographically dispersed.

Each greeter 7 greets a plurality of participants 4 in a preconference 16 simultaneously. The number of participants 4 greeted contemporaneously by a greeter 7 can range from one to tens of thousands.

At the conclusion of the greeting 9, participants 4 are transferred 12 from the preconference 16 to the econference 22. In one embodiment, the greeter 7 conducting the preconference initiates transfer. In one embodiment, a participant 4 may choose to immediately join the econference 22 prior to the conclusion of the preconference 16 via the participant interface.

A participant 4 may instead choose to disconnect from the preconference 16, and therefore not enter the econference 22. For an exemplary telephonic conference, a participant 4 may disconnect by hanging up the telephone.

In one embodiment, a participant 4 may request additional information about an econference 22 via an interface feature in the econferencing system. This may be particularly helpful if the preconference 16 is not otherwise interactive. Such an information request may be made during an entryway 6 or greeting 9. The requested information may be provided in a medium under control of the econferencing system which is separate from the means by which the corresponding preconferences 16 and econferences 22 are conducted. For example, additional information about a web-based chat conference may be provided by a video on a computer screen, even as video is not part of the econference 22.

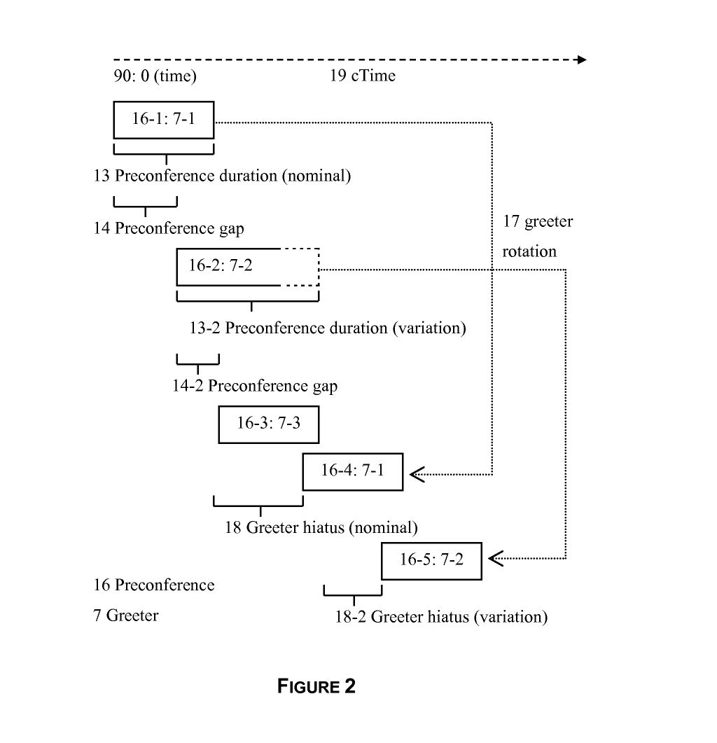

FIG. 2 depicts a diagram of greeters 7 during preconferences 16 for an econference 22. cTime 19 represents the time from the first preconference 16-1 following outbound initiation 1.

The first preconference 16-1 is hosted by a first greeter 7-1. The first preconference and corresponding entryway begins 90 when the first participant enters the preconference. Alternately, a first preconference may begin when invitations are sent, in anticipation of invitee acceptance.

A preconference 16 has a nominal duration 13, which may be predetermined for a particular econference 22. Preconference duration 13 is dependent upon the duration of its corresponding entryway 6 and greeting 9. Entryway 6 and greeting 9 durations may be predetermined for a preconference 16, or predetermined for all preconferences 16 of an econference 22, or may be variable. Entryway 6 and/or greeting 9 duration may be determined based upon the total number of greeters 7, the number of currently available greeters 7, the number of invitees 11, the number of invitees 11 that respond to an invitation 1, the number of participants 4 that disconnect from a preconference 16, available system resources, number of rounds of outbound initiation, or other determined or calculated factors. Additionally, entryway 6 duration may be determined based upon length of greetings 9. Additionally, greeting 9 duration may vary based upon greeter 7 speed and/or proclivities. Entryway 6 and greeting 9 durations may also vary dynamically based upon any of these factors and/or based upon the goals and/or resources of the econferencing system. Preconference duration may also vary 13-2 accordingly.

In a first embodiment, a preconference 16 may be interactive. For example, participants 4 may ask questions, or otherwise interact in a way that the greeter 9 responds to participant initiative. In absence of indication otherwise, this is the presumed embodiment.

In a second embodiment, a preconference 16 is a one-way expression. A monologue by a greeter 9 in a teleconference is exemplary. This second embodiment, with a greeter 9 providing an introduction without interactivity, is more specifically termed a prepresentation. Other than lacking interactivity, conducting a pre-presentation is selfsame to conducting a preconference 16.

In one embodiment, a preconference 16 may start with a greeter 7 before transitioning to an autogreeter 77, either in an entryway 6 or a greeting 9. In another embodiment, all or part of one or more preconferences 16 may be recorded, and then used, in whole or part, in subsequent preconferences 16. Portions of recorded preconferences 16 may be mixed together to construct an autogreeter 77.

Greeter 7 and autogreeter 77 may be alternately employed in any portion of a preconference 16. For example, a prerecorded message may be used to answer a question by a participant in an entryway 6 or greeting 9.

A second preconference 16-2 begins sometime after (preconference gap 14) the first preconference 16-1 begins. In the depicted embodiment of FIG. 2, the second preconference 16-2 begins while the first preconference 16-1 is still going on.

Multiple preconferences 16 may be contemporaneous. For example, the entryway 6 of a preconference 16-2 may begin while the greeting 9 of a previously-started preconference 16-1 is underway. Either entryways 6 or greetings 9 may overlap as well.

In a preferred embodiment, the start of a subsequent entryway 6 begins immediately after the previous entryway 6 ends and the greeting 9 starts. For example, the entryway of preconference 16-2 begins immediately following the conclusion of the entryway 6 of preconference 16-1, simultaneously with the beginning of the greeting of preconference 16-1.

Preconferences 16 may be scheduled as to starting time. In a different embodiment, a succeeding preconference 16 may begin after a predetermined duration after the previous preconference 16 began, or after a predetermined duration after the previous preconference 16 began and another participant accepts an invitation. In another embodiment, a succeeding preconference 16 begins once a predetermined number of participants 4 are in an entryway 6 and another participant 4 accepts an invitation 14.

A combination of preconference 16 timing embodiments is possible. For example, preconference 16 may be scheduled, but become ad hoc in some manner because of fewer or more participants 4 than expected, due to number or availability of greeters, or because of a change in available resources. The elapsed time between the beginning of preconferences 16 can vary 14-2.

Once a greeter 7 has finished a preconference 16, the greeter 7 may host a subsequent preconference 16 after taking a break/hiatus 18 of some duration. In one embodiment, a greeter 7 may decline a particular preconference 16, deciding instead for another (later) preconference. In one embodiment, greeters 7 may swap preconference 16 (time) slots.

In the depicted embodiment of FIG. 2, the first greeter 7-1 hosts the first preconference 16-1, then has a break 18 before hosting the fourth preconference 16-4. Likewise, the second greeter 7-2 takes a break 18-2 after the second preconference 16-2, though that hiatus 18-2 is of a different duration than the nominal greeter hiatus 18. Such greeter breaks may last from several seconds to several minutes. In one embodiment, a greeter 7 immediately goes from one preconference 16 to another, without a break. These are examples of greeter rotation 17, where a greeter conducts multiple preconferences 16 for an econference 22 through time. Generally, greeter rotation 17 employs greeters 7 in succession to contemporaneously greet different groups of participants 4.

There are various embodiments of how a particular greeter 7 is determined 8 for a preconference 16. In the preferred embodiment, a greeter 7 indicates readiness. In a second embodiment, greeters 7 are scheduled. In a variant of this embodiment, greeter hiatus 18 is predetermined, albeit possibly subject to change. In a third embodiment, a greeter 7 that has had the longest hiatus (break) 18-2 takes the next preconference 16. In a fourth embodiment, greeter 7 order is determined by a supervisor. Combinations of these embodiments for greeter determination 8 are possible.

The volume of outbound initiation may be determined variously in a variety of embodiments. In the preferred embodiment, simultaneous outbound initiation is determined by system capacity. If the system capacity can invite 1 all invitees 11 simultaneously, there is only one process of outbound invitation. Otherwise, multiple rounds of invitation ensue in order to invite 1 all invitees 11.

Each round of invitation may invite 1 a predetermined number of invitees 11, or a varying number of invitees 11 based upon system capacity. In the preferred embodiment, each round of invitation uses maximum system capacity. In this instance, the number of invitees 11 generally decreases with each round due to capacity of the system in use by participants 4 connected from previous rounds. Alternately, the number of invitees 11 may increase for a subsequent round due to participants 4 disconnecting.

In a second embodiment, outbound initiation is determined by the number of available greeters 7, given a preferred maximum size for a preconference 16. Like the preferred embodiment of outbound initiation, this second embodiment may involve one or multiple rounds of outbound initiation.

While in an econference 22, a participant 4 may select available features via an interface device or otherwise by request. These features may also be available to participants 4 during a preconference 16. A participant 4 may interact via any hardware or software interface to select these features, or may request a particular feature to a greeter 7. For example, during a telephone based teleconference, a participant may press a telephone key to select a specific feature.

Available features may be selected during a preconference 16 or econference 22. In one embodiment, participant initiation of available features may be limited to any portion of a preconference 16 or econference 22. In this limiting embodiment, the system simple refuses to accept the input, except perhaps to inform the invoker that the requested feature is not instantly available.

A participant 4 may request additional information about the econference 22. In this instance, the participant 4 is provided with additional information by the greeter 7, or via transfer to another preconference 16 or an autogreeter 77, or by transfer to an external source. Once the participant 4 has received the requested additional information, the participant 4 is transferred either back to a preconference 16 or to the econference 22. Alternately, the participant 4 may receive the requested additional information concurrently with participation in a preconference 16 or econference 22.

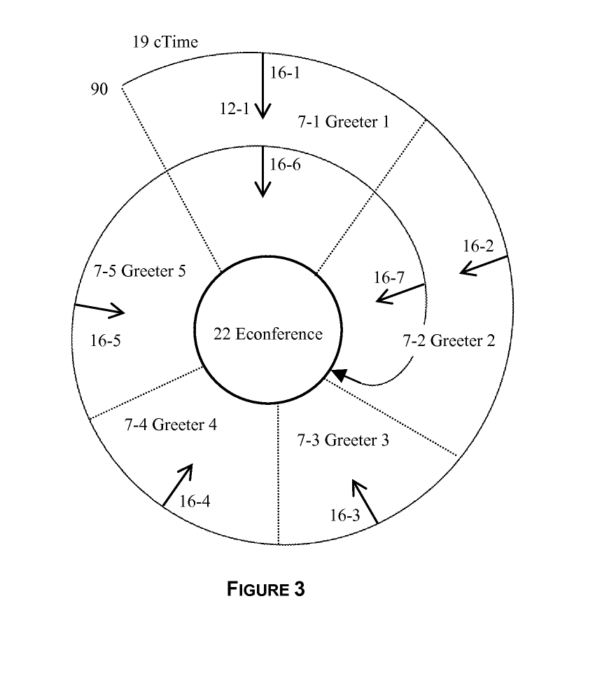

FIG. 3 shows exemplary rotation of greeters hosting preconferences 16 leading to an econference 22. FIGS. 2 and 3 are similar conceptually, but with different emphases. FIG. 2 depicts various timings, whereas FIG. 3 is from a greeter 7 perspective, providing a better sense of the time 19 slices in which different greeters 7 hold preconferences 16. As explained foregoing, preconferences 16 may overlap.

In FIG. 3, conference time 19 is depicted as spiraling towards the econference 22. While the preconference arrows, such as 16-1, nominally appear as a point in time, preconferences 16 of course occur over time during conference time 19, beginning with the start of the first preconference 90. The arrow suggests transfer (e.g., 12-1) into the econference 22.

In FIG. 3, there are seven preconferences (16-1 through 16-7) in an econference 22 employing five greeters (7-1 through 7-5). Once a preconference 16 is done, participants 4 are transferred 12 to the econference 22. For example, after greeter 7-1 has completed the first preconference 16-1, participants 4 are transferred 12-1 to the econference 22.

In FIG. 3, the first 7-1 and second 7-2 greeters each hold two preconferences 16: 16-1 and 16-6 for greeter 7-1; 16-2 and 16-7 for greeter 7-2. The other greeters (7-3 through 7-5) only have one preconference each (16-3 through 16-5 respectively).

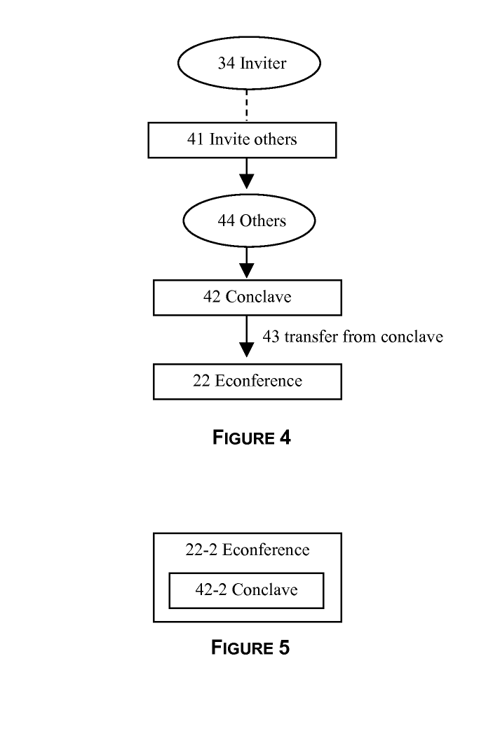

As depicted in FIG. 4, via the participant interface that allows access to an econference 22, or other interface means, a participant 4 may invite 41 others (one or more persons) 44 to join an econference 22. In a first embodiment example, a web-based conference participant may invite 41 others 44 by a phone call, text message, email, Internet chat, or other web-based interface, with the participant 4 providing the necessary information for others 44 to join. In a second invitation example, a participant 4 to a telephonic econference may invite 41 others 44 by email, text message, Internet chat, or other web-based interface that provides a dial-in telephone number.

While the econference was initiated for participants 4 via outbound initiation, others 44 join via a participant's invitation 41, followed by inbound initiation on the part of others 44 joining the econference 22.

In another embodiment, a participant 4 may initiate outbound invitation 41 to the others by invoking the econferencing system to include the others.

An inviter 34 is a participant 4 who initiates invitation 41 to others 44 to join an econference 22, regardless of how the invitation 41 is extended. An inviter 34 may be a single participant 4 or a group of participants 4.

The others 44 may be in the participant database, and so readily accessed by the system. Alternately, an inviter 34 may add others to a database prior to triggering outbound invitation 41. Alternately, an inviter 34 may directly invite 41 others 44, without interacting with the econferencing participant database system.

Inviting others 41 to an econference may transpire in one of several embodiments (termed inviter embodiments) or their combination.

In a first inviter embodiment, depicted in FIG. 4, the inviter 34 and others 44 may connect into their own conclave 42, where only they (inviter 34 and others 44) are in attendance. A conclave 42 is an exclusive conferencing interconnection between an inviter 34 and others 44 whom the inviter 34 has invited 41. From a conclave 42, the inviter 34 and others 44 may join 43 the econference 22. This embodiment is termed an inviter conclave.

In a variant embodiment of an inviter conclave, the inviter 34 and others 44 may join the next preconference 16 after a conclave 42 has finished, if a preconference 16 is still available. If a preconference 16 is not available, the conclave 42 participants join the econference 22.

In another inviter conclave embodiment, a conclave 42 group may optionally transfer 43 to an available preconference 16 or econference 22.

A pre-designated interface means, such as a button or key, is available to transfer 43 from a conclave 42 to an econference 22 or preconference 16, either via a hardware or software interface. Such interfaces are well known in the prior art.

In a second inviter embodiment, others 44 may be joined to the instant preconference 16 or econference 22 that the inviter 34 is in, able to hear and/or view the proceedings, but unable to actively interact. This embodiment is termed the others voyeur mode. In this second inviter embodiment, the inviter 44 may still be a participant 4 in the preconference 16 or econference 22.

In a third inviter embodiment, the inviter 34 and others 44 conclave 42 between themselves in private, while still able to hear and/or view the preconference 16 or econference 22 proceedings. This embodiment is a group commentary mode.

In a fourth inviter embodiment, the others 44 are brought into the econference 22 via outbound initiation, and join as if they were originally included participants 4. This is termed the others added mode.

In a fifth inviter embodiment, the others 44 are brought into a conclave 42 with the inviter 34, where they may interact amongst themselves without other econference participants 4 or live greeter 7 hearing or viewing them, but are also able to interact in a preconference 16 or econference 22 as participants 4. This conclave select mode is enabled by one of the conclave group (the inviter 34 and/or others 44) selecting a system feature that allows this. The inviter 34 and/or others 44, via a predetermined interface feature, may toggle between a conclave 42 and participation in the preconference 16 or econference 22.

In another variant embodiment, inviter 34 and others 44 may collectively toggle between conclave 42 and preconference 16 or econference 22 participation, based upon a plurality of indicated actions among the inviter 34 and others 44 in a conclave.

An exemplary fifth inviter embodiment for an econference involves pressing a predetermined conclave button to enter the conclave select mode. Entering the conclave select mode may be predetermined by the way that the inviter 34 invites the others 44. That is, conclave select mode is the default mode for inviting others. Alternately (in a different embodiment), conclave select mode is a separate feature that may be invoked.

In an exemplary sixth embodiment, depicted in FIG. 5, conclave select mode may be a feature by which participants can form a conclave 42-2 within an econference 22-2, irrespective of inviting others, though, in one embodiment, a conclave is started by inviting others. Conclave select mode may be enabled by participants selecting to join a conclave 42-2, either by accessing a conclave by number or name, or by participants identifying other participants who then accept a conclave invitation.

In various embodiments, participants may be transferred back to a preconference 16 after an econference 22, or a conclave 42-2 may continue after an econference 22 has concluded.

An econference 22 may be a commercial venue. In one embodiment, admission is nominally paid by participants 4 for admittance to an econference 22. Accepting participation 14 may trigger a payment mechanism. Alternately, the payment trigger may be deferred until transfer 12 into an econference 22. A variety of online payment techniques are known in the art of electronic commerce.

In an embodiment of commercial econferencing, a contest may be held to allow free entry into an econference 22 that is nominally a venue requiring participant 4 payment for admission. For example, an invitee 11 or participant 4 may be granted free access to a commercial econference 22 upon properly answering a question.

In various embodiments, preconferences 16 and/or econferences 22 may take polls or surveys, whereupon participants 22 register their opinions or reactions using the interface means by which econference participation is made possible.

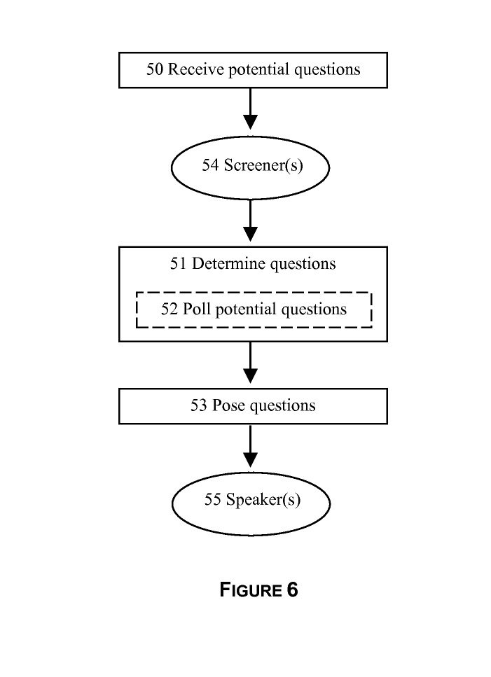

In the embodiments depicted in FIG. 6, questions are posed 53 to one or more econference speakers 55. A question may be a specific query, or as general as a request to address a particular topic.

In various embodiments, potential questions are received 50, either before preconferences 16 begin, during preconferences 16, or during an econference 22. Potential questions may be submitted by any medium; not necessarily the medium through which the econference 22 is held.

Screeners 54 determine questions 51 that may be posed during an econference. A screener 54 may be a person or software agent. Speech recognition software and language analysis software are exemplary software agent screeners. Such software technologies are known in the art.

In one embodiment, participants 4 are polled 52 to help determine questions 51. Such polling 52 may take place during preconferences 16, or beforehand.

Once in the econference 22, the determined questions are posed 53 to the one or several speakers 55 who are presenting the econference 22. The one or more speakers 55 may ultimately decide which questions they care to address.

Alternately, polling 52 may take place during an econference 22, with questions posed later 53 in that econference 22 or saved for a later econference 22.

In another embodiment, questions may be posed 53 to a greeter 7 during a preconference 16, where polling 52 takes place during the preconference 16, or beforehand. Questions may be determined 51 based upon all received poll 52 responses, or based on a subset of responses from the participants 4 of the instant preconference 16.

The econferencing system disclosed records and accumulates statistical information relating to various aspects of the disclosed econferencing system, including: responses to outbound initiation (e.g., percentage of participants 4, non-respondents 5 and refusers 33); preconference 16 (entryway 6 and greeting 9) durations; any participant actions within preconferences 16 (including, for example, dropping out, leaving a preconference prior to its completion and joining an econference 22, and conclave 42 activity); any participant 4 actions within econferences 22; participant 4 selection of optional econferences 22; greeter 7 activity, such as number of preconferences 16 held for an econference 22, as well as aforementioned preconference 16 statistics on a per greeter 7 basis. Such statistical information may be collated in various ways, so as to measure, for example, greeter 7 performance, efficiency of outbound initiation, and participant 4 satisfaction with econference 22 content and the performance of the (hardware and software) system used for econferencing.

Many of the terms disclosed herein, specifically: econference, preconference, entryway, greeting, greeter, autogreeter, active connection, participant, invitee, inviter, refuser, outbound communication, inbound communication, non-respondent, epresentation, prepresentation, question, conclave, cTime, screener, and canned, are explicitly defined via the privilege of the applicant acting as lexicographer. The broadest reasonable constructions of such terms are within the scope explicitly defined: neither broader nor narrower than one of skill in the art with native fluency in English would construe.

A variety of embodiments are contemplated in various combinations of features, techniques, methods, and systems as disclosed herein.

The following is claimed:

1. A method of conducting an electronic conference comprising:
contemporaneously initiating contact with a first plurality of people;
putting a second plurality of people into contact with a first live greeter,
wherein a live greeter is a living person, and
wherein said second plurality of people comprises at least a portion of said first plurality of people;
said first live greeter simultaneously communicating with said second plurality of people;
transferring at least a portion of said second plurality of people to an electronic conference;
putting a third plurality of people into contact with a second live greeter,
wherein said third plurality of people comprises at least a portion of said first plurality of people;
said second live greeter simultaneously communicating with said third plurality of people; and
transferring at least a portion of said third plurality of people to said electronic conference.

2. A method of conducting an electronic conference comprising:
contemporaneously initiating contact with a first plurality of people;
a first set of said first plurality of people affirmatively responding to said contact within a first time period,
whereby connecting said first set of people with a first live greeter,
wherein a live greeter is a living person;
a second set of said first plurality of people affirmatively responding to said contact within a second time period,
wherein said second time period occurs after said first time period,
whereby connecting said second set of people with a second live greeter; and
whereby transferring said first set and said second set of people to an electronic conference.

3. A method of conducting an electronic conference comprising:
contemporaneously initiating contact with a first plurality of people;
a first live greeter conducting a first preconference for a first set of people responding to said contact,
wherein a live greeter is a living person;
wherein said first preconference comprises an entryway and a greeting,
wherein said entryway comprises a duration wherein additional people, from said first plurality, may join said first set of people in said preconference, and
wherein said greeting comprises a duration wherein no additional people may join said preconference; and
transferring said first set of people to an electronic conference comprising a second plurality of people.

4. The method according to claim 1, further comprising:
putting a fourth plurality of people into contact with said first live greeter;
said first live greeter simultaneously communicating with said fourth plurality of people subsequent to said second live greeter beginning to simultaneously communicate with said third plurality of people; and
transferring at least a portion of said fourth plurality of people to said electronic conference.

5. The method according to claim 4, such that said first live greeter takes a break between transferring at least a portion of said second plurality of people to said electronic conference and putting said fourth plurality of people into contact with said first live greeter.

6. The method according to claim 1, wherein said third plurality of people differs from said second plurality of people by responding to said contemporaneously initiating contact at a different time interval.

7. The method according to claim 1, wherein a live greeter simultaneously communicating with a plurality of people comprises a preconference,
said preconference comprising two sequential periods of time,
wherein a first period of said preconference comprises an entryway, and
wherein a second period of said preconference comprises a greeting,
such that during said entryway additional people may join said preconference, and such that during said greeting additional people may not join said preconference.

8. The method according to claim 7, further comprising:
said first live greeter responding to input from a first participant among said second plurality of people,
wherein said input occurs during said preconference.

9. The method according to claim 8, such that said first live greeter response to said input occurs during said greeting.

10. The method according claim 7, wherein employing an autogreeter during at least a portion of said preconference.

11. The method according to claim 2, wherein the duration between the start of said first time period and the start of said second time period is predetermined.

12. The method according to claim 2, wherein the duration between the start of said first time period and the start of said second time period is not predetermined.

13. The method according to claim 2, further comprising:
a third set of said first plurality of people affirmatively responding to said contact within a third time period,
wherein said third time period occurs after said second time period,
whereby connecting said third set of people with said first live greeter; and
whereby transferring said third set of people to said electronic conference.

14. The method according to claim 13, such that a break elapses between transferring said first set of people to said electronic conference and connecting said third set of people with said first live greeter.

15. The method according to claim 13, wherein said first live greeter connecting with said third set of people is predetermined.

16. The method according to claim 13, wherein said first live greeter connecting with said third set of people is not predetermined.

17. The method according to claim 3, further comprising:
a second live greeter conducting a second preconference for a second set of people responding to said contact,
wherein an entryway of said second preconference begins contemporaneous with the beginning of said greeting of said first preconference.

18. The method according to claim 3, further comprising:
a second live greeter conducting a second preconference for a second set of people from said first plurality,
wherein said second set of people differs from said first set of people by responding to said contact during a different time period; and
transferring said second set of people to said electronic conference.

19. The method according to claim 18, further comprising:
said first live greeter conducting a third preconference for a third set of people,
wherein said third set of people differs from said first set of people by responding to contact during a different time period than said first set of people.

20. The method according to claim 19, wherein said third set of people respond to contact initiated at a different time period from said initiating contact with said first plurality of people.
